(19) United States
(12) Patent Application Publication
(10) Pub. No.: US 2025/0033249 A1
(43) Pub. Date: Jan. 30, 2025

(54) METHOD FOR PREPARING A COMPOSITE CONSTRUCTION MATERIAL

(71) Applicant: The Hong Kong University of Science and Technology, Hong Kong (CN)

(72) Inventors: Charles Wang Wai NG, Hong Kong (CN); Pui San SO, Hong Kong (CN); Sze Yu LAU, Hong Kong (CN)

(21) Appl. No.: 18/782,175

(22) Filed: Jul. 24, 2024

Related U.S. Application Data
(60) Provisional application No. 63/515,346, filed on Jul. 25, 2023.

(51) Int. Cl. B29B 17/00; B29K 23/00; B29K 105/26; B29K 509/00; B29K 509/06; F28F 13/18

(52) U.S. Cl. CPC B29B 17/0042; F28F 13/18; B29K 2023/00; B29K 2105/26; B29K 2509/06; B29K 2509/14

(57) ABSTRACT

A method for preparing a composite construction material, the method including: combining plastic waste and construction waste, such as construction debris, crushed rock, stone, concrete rubbles, soil, or a mixture thereof, thereby forming a waste mixture; and curing the waste mixture under oxygen-free conditions thereby melting or softening at least a portion of the plastic waste and forming the composite construction material.

### CROSS-REFERENCE TO RELATED APPLICATIONS

The present application claims priority from U.S. Provisional Patent Application No. 63/515,346, filed on Jul. 25, 2023, which is hereby incorporated by reference in its entirety.

### TECHNICAL FIELD

The present disclosure concerns a method of producing cementless materials. More particularly, the present disclosure provides a production method using construction waste and plastic waste without adding cement.

### BACKGROUND

Ever increasing global population and intense human activity are worsening emissions of greenhouse gases, especially carbon dioxide (CO₂), which accelerates global warming and causes climate change. According to Intergovernmental Panel on Climate Change (IPCC, 2019), when the global mean temperature rises by 1.5° C. compared with preindustrial levels between 1850 and 1900, there are irreversible losses of ecosystem functioning, biodiversity and ice sheets, jeopardising food production as well as human lives. To avoid such a temperature rise, it is necessary to reduce global net CO₂ emissions to zero by around 2050. Most countries in the world are, therefore, committed to a climate action framework called the Paris Agreement and are devoted to sustainable development and carbon neutrality.

The construction industry is a major contributor to global CO₂ emissions. Typically, concrete is a construction material adopted for various applications including road pavements, walls and buildings. It consists of cement and natural aggregates (e.g., sand, rock, stone, etc.), which are defined as binders and fillers, respectively. However, cement production is energy-intensive and accounts for nearly 10% global CO₂ emissions (Monteiro et al., 2017). Each ton of cement generates around one ton of CO₂ during its production. When constructing a building, around 60% of the CO₂ emissions can be attributed to material production (UKGBC, 2015). Furthermore, construction materials can be disposed of to become waste during construction works, such as building demolition, renovation, ground levelling and road paving. As construction waste is usually inorganic and inert, it is typically dumped in landfills. This may contaminate soil and ground water, leading to land degradation. Based on the statistics from the United States Environmental Protection Agency, the European Union and research institutes in China, the amount of construction waste in these countries accounts for 15%-70% of total municipal solid waste (MSW) (QIRI, 2018; USEPA, 2020; Eurostat, 2022). Therefore, there are calls for developing sustainable construction materials as alternatives to the conventional options to minimize significant amounts of CO₂ and waste.

In addition to construction waste, plastic waste is another major MSW that is encountered by different countries. The present global production of plastic has reached nearly 390 million tonnes per annum, which is a 260-fold increase compared with the amount in 1950 (Statista, 2023). The increased plastic production is also accompanied by severe waste generation. Currently, the recycling rate of plastic waste is still relatively low while most plastic waste is addressed by landfilling. For instance, about 9% of plastic waste in America was recycled, while nearly 76% of plastic waste was disposed of in landfills (USEPA, 2020). Even though incineration may be efficient to deal with non-biodegradable plastic waste, a significant amount of CO₂ can be emitted. The amount of CO₂ emitted is equal to three times the mass of plastic incinerated (Vollmer, 2020). Together with construction waste, inventing sustainable solutions is necessary to recycle and reuse both types of wastes to facilitate carbon neutrality. Preferably, the recycled wastes can be incorporated into construction materials in order to minimize CO₂ emissions from the construction industry.

To make concrete more sustainable, replacing a part of natural aggregates (i.e., sand, rock, stone, etc.) in concrete with construction waste and plastic waste has been actively investigated. Within this decade, over a hundred studies were conducted to examine the properties of concrete with aggregates that consist of construction waste and plastic waste. Although the wastes are reused in this approach, additional cement is needed to bind the aggregates, which causes secondary emissions of CO₂. On the other hand, the feasibility of using plastic waste as a part of binders in construction materials is explored. Polyethylene (PE) can be mixed with bitumen for constructing road pavements. When bitumen is heated during pavement construction, PE becomes molten and binds natural aggregates. Obviously, such method is only applicable to a given type of plastic waste (i.e., PE) and bitumen-based materials. Besides, carbon-intensive bitumen is still the dominant binder. These limit the efficiency of recycling and reusing plastic waste and confine the application of the materials produced. Recently, heating plastic waste, such as PE and polypropylene (PP) to replace cement for binding natural aggregates has been attempted (Dalhat and Wahhab, 2016). The working principle is to first increase the heating temperature to achieve melting and then compact the molten mixture to form a specimen. However, during the heating, plastic waste can undergo oxidation (e.g., combustion) due to the presence of impurities including the materials of aggregates. This can release toxic fumes and cause degradation or burning of plastic, which defeats the intended purpose to be a binder. Most plastic wastes are not guaranteed to turn into binders simply by heating. It has also been found that adding more plastic waste to fired bricks further reduces the strength of the bricks (Akinyele et al., 2020). Furthermore, controlling the temperature of plastic waste accurately near its melting point is necessary but relatively impractical since the boundary temperature (e.g., heating elements, moulds, etc.) can affect the melting and even cause burning of plastic (Sun et al., 2022). More importantly, construction waste is not recycled and reused in this type of technology.

In effect, no method of efficiently producing sustainable materials using only construction waste and plastic waste without cement has yet been demonstrated. There is thus a need for improved methods for producing composite construction materials from construction waste and plastic waste that address or overcome at least some of the shortcomings discussed above. Furthermore, other desirable features and characteristics will become apparent from the subsequent detailed description and the appended claims, taken in conjunction with the accompanying drawings and this background of the disclosure.

### SUMMARY

A method of producing sustainable materials is described herein. The production only requires construction waste and plastic waste without the use of cement. Construction waste and plastic waste which serve as fillers and binders, respectively, are uniformly mixed. The waste mixture is moulded and cured at the temperature near to and higher than the melting point of the plastic waste. The environment for curing the mixture can be supplied with inert gases (e.g., nitrogen, carbon dioxide, etc.) or under vacuum to avoid oxidation (e.g., combustion) of the wastes and release of toxic gases. The plastic waste can contain single or multiple types of plastic, simplifying the requirement of sorting and purifying the waste. After curing, plastic waste binds and reinforces construction waste to form new sustainable materials.

This methodology not only converts both construction and plastic waste into economically viable cementless materials for many applications, but also contributes to CO₂ reduction and carbon neutrality by upcycling wastes and minimizing the use of conventional carbon-intensive construction materials (e.g., cement).

In a first aspect, the present disclosure provides a method for preparing a composite construction material, the method comprising: combining plastic waste and construction waste thereby forming a waste mixture; and curing the waste mixture under oxygen-free conditions thereby melting or softening at least a portion of the plastic waste and forming the composite construction material.

In certain embodiments, the construction waste comprises concrete, bitumen, asphalt, rubble, rock, aggregate, construction debris, crushed rock, stone, concrete rubble, soil, crushed glass, brick, tile, ceramic, gypsum board, or a mixture thereof.

In certain embodiments, the plastic waste comprises polyethylene, polypropylene, polyethylene terephthalate, polyvinyl chloride, polystyrene, acrylonitrile butadiene styrene, polycarbonate, nylon, poly(methyl methacrylate), polylactic acid (polylactide), polyether sulfone, polyoxymethylene, polyether ether ketone, polyetherimide, polyphenylene oxide, polyphenylene sulphide, polyvinylidene fluoride, polytetrafluoroethylene, or a mixture thereof.

In certain embodiments, the plastic waste comprises polyethylene, polypropylene, or a mixture thereof.

In certain embodiments, the composite construction material comprises at least 5% by weight of the plastic waste relative to the total weight of plastic waste and construction waste.

In certain embodiments, the composite construction material comprises at least 10% by weight of the plastic waste relative to the total weight of plastic waste and construction waste.

In certain embodiments, the step of combining plastic waste and construction waste further comprises combining water thereby forming the waste mixture with a gravimetric water content of 5-20%; and moulding the waste mixture prior to curing the waste mixture.

In certain embodiments, curing the waste mixture is conducted at a temperature at ±20° C. of a melting point of the plastic waste.

In certain embodiments, curing the waste mixture is conducted at a temperature at ±5° C. of a melting point of the plastic waste.

In certain embodiments, the method further comprises the step of determining the melting point of the plastic waste.

In certain embodiments, the oxygen-free conditions comprise vacuum or an inert atmosphere comprising nitrogen, carbon dioxide, helium, argon, or a mixture thereof.

In certain embodiments, the composite construction material has an unconfined compressive strength of at least 2.4 MPa measured in accordance with ASTM D2166M-16.

In certain embodiments, the construction waste comprises construction debris, crushed rock, stone, concrete rubbles, soil, or a mixture thereof; the plastic waste comprises polyethylene, polypropylene, polyethylene terephthalate, polyvinyl chloride, polystyrene, or a mixture thereof; the composite construction material comprises at least 5-40% by weight of the plastic waste relative to the total weight of plastic waste and construction waste; curing the waste mixture is conducted at a temperature at ±20° C. of a melting point of the plastic waste; and wherein the oxygen-free conditions comprise vacuum or an inert atmosphere comprising nitrogen, carbon dioxide, helium, argon, or a mixture thereof.

In certain embodiments, the composite construction material has an unconfined compressive strength of at least 2.4 MPa measured in accordance with ASTM D2166M-16.

In certain embodiments, the construction waste comprises construction debris, crushed rock, stone, concrete rubbles, soil, or a mixture thereof; the plastic waste comprises polyethylene, polypropylene, or a mixture thereof; the composite construction material comprises at least 10-40% by weight of the plastic waste relative to the total weight of plastic waste and construction waste curing the waste mixture is conducted at a temperature at ±5° C. of a melting point of the plastic waste; and wherein the oxygen-free conditions comprise vacuum or an inert atmosphere comprising nitrogen, carbon dioxide, helium, argon, or a mixture thereof.

In certain embodiments, the composite construction material has an unconfined compressive strength of 2.4-7 MPa measured in accordance with ASTM D2166M-16.

In certain embodiments, the method further comprises the step of determining the melting point of the plastic waste.

In certain embodiments, the method further comprises applying a surface treatment to at least one surface of the composite construction material, wherein the surface treatment comprises a radiative cooling coating, a radiative cooling paint, or a mixture thereof.

In certain embodiments, the radiative cooling coating comprises silicone and a metal oxide selected from the group consisting of magnesium oxide, aluminium oxide, titanium oxide and silicon oxide.

In certain embodiments, the radiative cooling paint comprises titanium dioxide, barium sulphate, and a polyvinylidene fluoride-hexafluoropropylene copolymer.

### BRIEF DESCRIPTION OF THE DRAWINGS

The above and other objects and features of the present disclosure will become apparent from the following description of the disclosure, when taken in conjunction with the accompanying drawings.

FIG. 1 indicates the unconfined compressive strength of only construction waste cured at four different temperatures. Note: At a given temperature, there are three replicates.

FIG. 2 shows the unconfined compressive strength of construction waste mixed with plastic waste (i.e., PE) at various concentrations after curing with 150° C. in air. Note: The strength is reported as average±standard error, n=3.

FIG. 3 shows the unconfined compressive strength of construction waste mixed with different amounts of plastic waste (i.e., PP) after curing at different temperatures in air. Note: The strength is reported as average±standard error, n=3.

FIG. 4 depicts the unconfined compressive strength of construction waste with 5% PP after curing at 185° C. in different types of gas. Note: The strength is given as average±standard error, n=3.

FIG. 5 presents the unconfined compressive strength of construction waste mixed with different amounts of PP after curing at 185° C. in vacuum. Note: The value is reported as average±standard error, n=3.

### DETAILED DESCRIPTION

### Definitions

The following terms shall be used to describe the present invention. In the absence of a specific definition set forth herein, the terms used to describe the present invention shall be given their common meaning as understood by those of ordinary skill in the art.

Throughout the present disclosure, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the present invention.

Furthermore, throughout the present disclosure and claims, unless the context requires otherwise, the word “include” or variations such as “includes” or “including”, will be understood to imply the inclusion of a stated integer or group of integers, but not the exclusion of any other integer or group of integers.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

The terms “fine aggregates” and “coarse aggregates” used herein are not intended to limit a range of sizes but are simply used to indicate that one type of aggregate contains larger particles than the other type. For example, in a cement mixture containing two types of fine sand, the fine sand with larger particles will be called coarse aggregate.

An objective of the present disclosure is to provide a method for producing a composite construction material from a mixture of construction waste and plastic waste in absence of cement. This disclosure also provides an improved method for curing mixtures of construction and plastic waste so that plastic waste binds and strengthens construction waste efficiently without causing plastic oxidation (e.g., combustion) and toxic gas generation during curing.

The present disclosure provides a method for preparing a composite construction material, the method comprising: combining plastic waste and construction waste thereby forming a waste mixture; and curing the waste mixture under oxygen-free conditions thereby melting or softening at least a portion of the plastic waste and forming the composite construction material.

Construction waste useful in the methods described herein can include any type of unwanted materials produced during construction work, including but not limited to the construction and demolition of buildings, ground levelling and road paving. In certain embodiments, the construction waste is substantially inert construction waste, including but not limited to concrete, bitumen, asphalt, construction debris, rubble, rock, soil, aggregate, glass, brick, tile, ceramic, gypsum board and mixtures thereof.

The aggregates can be coarse aggregates, fine aggregates, or a mixture thereof.

The coarse aggregates can be coarse gravel, medium gravel, fine gravel, crushed rock, pebbles, stones, concrete rubble, river gravel, sea gravel, crushed glass, slate waste, waste plastics, recycled coarse aggregate derived from demolition waste and combinations thereof.

The waste mixture can comprise 60% or less, 65% or less, 70% or less, 75% or less, 80% or less, 85% or less, 90% or less, or 95% or less by weight of the construction waste relative to the total weight of plastic waste and construction waste. In certain embodiments, the waste mixture comprises 60-95%, 60-90%, 60-85%, 60-80%, 60-75%, 60-70%, 60-65%, 65-95%, 70-95%, 75-95%, 80-95%, 85-95%, 90-95%, 70-90%, 70-85%, 70-80%, 70-75%, 75-90%, or 80-85% by weight of the construction waste relative to the total weight of plastic waste and construction waste. In certain embodiments, the waste mixture comprises about 60%, about 75%, about 80%, about 85%, or about 90% by weight of the construction waste relative to the total weight of plastic waste and construction waste.

The construction waste can optionally be dried to remove any residual moisture prior to use in the methods described herein. In certain embodiments, the construction waste is air-dried or dried at a temperature between 40-150° C., 60-150° C., 80-150° C., 80-130° C., 40-110° C., 80-110° C., 60-110° C., 90-110° C., or about 100° C.

Plastic waste can include any plastic discarded after use or waste generated by any industrial processes or by consumers. Exemplary types of plastic waste include, but not limited to polyethylene, polypropylene, polyethylene terephthalate, polyvinyl chloride, polystyrene, acrylonitrile butadiene styrene, polycarbonate, nylon, poly(methyl methacrylate), polyether sulfone, polyoxymethylene, polyether ether ketone, polyetherimide, polyphenylene oxide, polyphenylene sulphide, polyvinylidene fluoride, polytetrafluoroethylene, and combinations thereof. In certain embodiments, the waste plastic comprises polyethylene, polypropylene, or a mixture thereof.

The waste mixture can comprise at least 5%, at least 10%, at least 15%, at least 20%, at least 25%, at least 30%, at least 35%, or at least 40% by weight of the plastic waste relative to the total weight of plastic waste and construction waste. In certain embodiments, the waste mixture comprises 5-40%, 10-40%, 15-40%, 20-40%, 25-40%, 5-35%, 5-30%, 5-25%, 5-20%, 5-15%, 5-10%, 10-30%, 15-30%, 20-30%, 25-30%, 10-25%, or 15-20% by weight of the plastic waste relative to the total weight of plastic waste and construction waste. In certain embodiments, the waste mixture comprises about 10%, about 15%, about 20%, about 25%, or about 40% by weight of the plastic waste relative to the total weight of plastic waste and construction waste.

In certain embodiments, the construction waste and plastic waste are mixed at any mass ratio sufficient for the plastic waste to act as a binder after curing. The mass ratio of the construction waste and plastic waste can be 1:19 to 2:3, 1:19 to 1:4, 1:19 to 1:9, 1:9 to 2:3, or 1:4 to 2:3, respectively. The plastic waste can contain single or multiple types of plastic.

In certain embodiments, the construction waste and the plastic waste can first be crushed to reduce their particle sizes, which increases the surface area and can improve curing. The crushed wastes can be sieved to obtain a certain size and then mixed together at various mass ratios. There are various known methods for controlling the particle size of a material, including cutting, tearing, breaking, shredding, grinding, pulverizing, jet milling, hammer milling, compression milling and tumble milling processes and/or other mechanical size reduction techniques. In certain embodiments, the particle size of the construction waste and plastic waste is first reduced and then passed through a sieve including, but not limited to 10-mm, 5-mm, 4-mm, 3-mm, 2-mm, or 1-mm sieve, to improve the homogeneity of waste particles.

In certain embodiments, the waste mixture is moulded prior to curing the waste mixture. To facilitate the moulding of the waste mixture, water can be added. Accordingly, the method can further comprise combining water with the plastic waste and construction waste or the waste mixture thereby forming the waste mixture having a gravimetric water content of 5-80%, 5-70%, 5-60%, 5-50%, 5-40%, 5-30%, 5-20%, 10-20%, 15-20%, 5-15%, or 5-10%.

The waste mixture can optionally be moulded by using a mould having a desired shape to fulfil the requirements of the intended application of the composite construction material. The moulded waste mixture can take any shapes that can be formed with a mould, including but not limited to spherical, cubical, cuboid, cylindrical, conical, pyramidal, hollow, sheets, tubes, and the like.

The waste mixture can be cured at a temperature near or above the melting point of plastic waste thereby melting or softening at least a portion of the plastic waste in the waste mixture thereby binding the construction waste. Curing the waste mixture is conducted at a temperature at ±20° C., ±19° C., ±18° C., ±17° C., ±16° C., ±15° C., ±14° C., ±13° C., ±12° C., ±11° C., ±10° C., ±9° C., ±8° C., ±7° C., ±6° C., ±5° C., ±4° C., ±3° C., ±2° C., ±1° C. of the melting point of the plastic waste or at the melting point of the plastic waste. In certain embodiments, heat treatment of the waste mixture is conducted at a temperature less than 20° C., less than 19° C., less than 18° C., less than 17° C., less than 16° C., less than 15° C., less than 14° C., less than 13° C., less than 12° C., less than 11° C., less than 10° C., less than 9° C., less than 8° C., less than 7° C., less than 6° C., less than 5° C., less than 4° C., less than 3º° C., less than 2° C., less than 1° C. or at the melting point of the plastic. In certain embodiments, heat treatment of the waste mixture is conducted at a temperature less than 20° C., less than 19° C., less than 18° C., less than 17° C., less than 16° C., less than 15° C., less than 14° C., less than 13° C., less than 12° C., less than 11° C., less than 10° C., less than 9° C., less than 8° C., less than 7° C., less than 6° C., less than 5° C., less than 4° C., less than 3° C., less than 2° C., or less than 1° C. above the melting point of the plastic. In certain embodiments, heat treatment of the waste mixture is conducted at a temperature about the melting point of the plastic waste.

Given that it can be difficult to predict the melting point or softening point of plastic waste due to the presence of a mixture of plastics with differing melting points, impurities, unknown plastics, or an unknown ratio of the plastics present in the plastic waste, the methods described herein can further comprise the step of determining the melting point or the softening point of the plastic mixture.

In certain embodiments, the curing time required should be sufficient for at least a portion of the plastic waste to melt and/or soften. In certain embodiments, the waste mixture is cured for 1-10 hours, 1-9 hours, 1-8 hours, 1-7 hours, 1-6 hours, 2-6 hours, 3-6 hours, 3-5 hours, 3-4 hours, or 2-5 hours. In certain embodiments, the waste mixture is cured for about 4 hours.

The step of curing the waste mixture can be conducted in air or under oxygen-free conditions selected from vacuum or an inert atmosphere, such as nitrogen, carbon dioxide, helium, argon, or a mixture thereof. Advantageously, when the step of curing the waste mixture is conducted in an inert atmosphere or under vacuum, oxidation of plastic waste can be reduced or avoided all together thereby reducing the release of toxic waste gas.

In certain embodiments, the pressure/concentration of inert gas supplied to the environment for curing can be any level at or above the atmospheric pressure to reduce the oxygen content in the environment and avoid oxidation of plastic waste and generation of toxic gas. In certain embodiments, the inert gases at 10 kPa gauge pressure can be provided to displace oxygen gas in a confined space.

In certain embodiments, vacuum applied to the environment for curing the waste mixture is any pressure below the atmospheric pressure to remove air from the environment and avoid oxidation of plastic waste. In certain embodiments, the pressure applied to the environment is at or below −80 kPa gauge pressure.

In certain embodiments, the vessel used for curing the waste mixture can be any vessel that enables the control of temperature and/or atmospheric conditions. The vessel can include, but is not limited to, a tank, a container, a swap body, a drum, an environmental chamber, a thermal vacuum chamber and/or a room.

A silicone layer can optionally be applied to at least one surface of the composite construction material to facilitate passive radiative cooling, which reduces the surrounding temperature.

In certain embodiments, the passive radiative cooling effect of silicone coating can be improved by adding metal oxides, including but not limited to magnesium oxide, aluminium oxide, titanium oxide and silicon oxide, into the silicone. The mass ratio of metals oxides to silicone should be 5% preferably. The passive radiative cooling effect of the silicone can also be enhanced by first applying radiative cooling white paint on the cured waste mixture and then spraying silicone on the top of the paint. The composition of the white paint includes but not limited to titanium oxide, barium sulphate and polyvinylidene fluoride-hexafluoropropylene copolymer.

The composite construction material described herein can be adopted for diverse applications, such as engineering works including buildings, retaining walls, partition walls, structural walls, road pavements, landscaping, and precast units.

Advantageously, the composite construction material can exhibit an unconfined compressive strength of at least 2.4 MPa measured in accordance with ASTM standard D2166M-16. In certain embodiments, the composite construction material has an unconfined compressive strength of 2.4-7 MPa.

The methods described herein provide numerous advantages including, but not limited to:
1. Upcycle construction waste and plastic waste by converting these wastes into economically viable sustainable materials without using cement and raw materials;
2. Avoid oxidation of plastic waste and generation of toxic gas during curing of waste mixture, leading to better bond formed between the wastes and stronger materials produced;
3. Improve production flexibility and efficiency by simplifying the sorting of wastes and lowering the requirement of temperature control for curing;
4. Advance the functionality of the developed materials by coating the material surface with silicone to provide passive radiative cooling. The cooling effects can be enhanced by adding metal oxides to silicone and putting a radiative cooling white paint first before silicone is coated;
5. Curb reliance on conventional construction materials and minimize CO₂ emissions from construction industry to promote carbon neutrality.

### EXAMPLES

### Example 1—Strength of Construction Waste with and without Plastic Waste (i.e., PE) after Curing in Air

In this example, construction waste, which comprises construction debris, crushed rock, stone, concrete rubbles and soil, is adopted. Plastic waste corresponding to PE is also considered. To remove moisture, the two wastes are oven-dried at 100° C. for a day. They are then crushed into small pieces using a grinder and passed through a sieve to improve the homogeneity of test specimens. The particle size of construction waste and plastic waste is smaller than 2 mm and 48 μm, respectively. Plastic waste is added to construction waste at different mass ratios including 5%, 10% and 20%. The wastes are then mixed thoroughly with deionized water. The gravimetric water content of waste mixture is around 14%. For the control condition, the construction waste is mixed with only deionized water. The mixture is compacted inside a metal mould to form a cylindrical specimen with 50 mm diameter and 100 mm height. Dry density of specimens is 1,410 kg/m³. The control specimens without plastic waste are cured at four temperatures in air and two temperatures in vacuum. The four temperatures include 150° C., 200° C., 250° C. and 265° C. while 325° C. and 340° C. are adopted for the vacuum conditions. Besides, the specimens with plastic waste are cured in air at 150° C. which is slightly higher than the melting point of PE (i.e., ˜110-145° C.). The curing time of all test conditions is 4 hours. Each test condition has three replicates. After curing, unconfined compression test is conducted according to ASTM Standard D2166M-16. The specimens are sheared at 1 mm min⁻¹. During shearing, a load cell and a liner variable differential transformer are used to measure the axial stress and axial deformation of the specimens, respectively. The peak axial stress measured corresponds to the strength of the specimen.

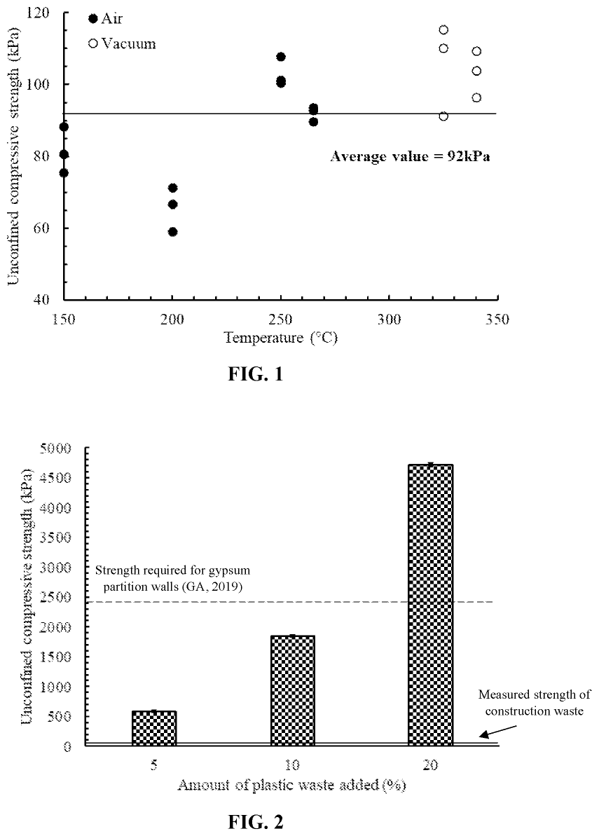

FIG. 1 indicates the unconfined compressive strength of construction waste without treatment after curing at different temperatures. For those temperatures under consideration, three replicates are measured. When the curing temperature increases from 150° C. to 340° C., the strength of construction waste ranges from 59 kPa to 115 kPa with an average value of around 92 kPa. The maximum strength of the specimens cured in air and vacuum is 108 kPa and 115 kPa, respectively. The difference in the maximum strength of the specimens cured with the two methods is less than 10%. These results show that the strength of pure construction waste is independent of curing temperature and gas due to no bonding agents added. When plastic waste (i.e., PE) is added to construction waste, the strength of construction waste with plastic waste after curing in air is shown in FIG. 2. The strength of construction waste increases with an increasing amount of plastic waste added as more plastic waste is available to bind construction waste after curing. When the amount of plastic waste added reaches 20%, the strength of construction waste with plastic waste is increased to 4.7 MPa which is higher than the typical strength required for regular gypsum partition walls (GA, 2019). The strength increase after treatment is also around 54-folds of the strength of construction waste without treatment. Therefore, curing the construction waste with some types of plastic waste in air is feasible to produce materials for different applications.

### Example 2—Strength of Construction Waste with Plastic Waste (i.e., PP) after Curing in Different Types of Gas

This example considers curing construction waste with another type of plastic waste in air and in the environment applied with an inert gas or vacuum. The construction waste comprises construction debris, crushed rock, stone, concrete rubbles and soil while the type of plastic waste is PP. Initially, both construction waste and plastic waste are oven-dried at 100° C. for 24 hours to remove any moisture. To ensure homogeneity of test specimens, the wastes are crushed into small pieces using a grinder and passed through different sizes of sieves. The particle size of construction waste is smaller than 2 mm. For the plastic waste, the size smaller than 48 μm is chosen to prepare the specimens cured in air while the size less than 500 μm is selected to prepare the specimens cured in the inert gas and vacuum. To prepare test specimens, the sieved plastic waste is first added to the sieved construction waste at different mass ratios. The waste mixture is then added with deionized water uniformly. After that, the mixture is compacted in a metal mould to form a cylindrical specimen with 50 mm diameter and 100 mm height. Three test series are conducted in this example. In the first series, the plastic waste at two concentrations, namely 5% and 10%, is added. Dry density and gravimetric water content of specimens are 1410 kg/m³ and 14%, respectively. Three curing temperatures corresponding to 100° C., 150° C. and 185° C. are adopted. Only the latter one is higher than the melting point of the plastic waste (i.e., ˜160-170° C.). Curing the specimens in air is adopted. For the second series, 5% plastic waste is added to the construction waste. The dry density and water content are the same as the first series while the highest temperature adopted in the first series is selected to cure the specimens. Various types of gas, namely air, nitrogen and vacuum, are applied for curing. The gauge pressure of nitrogen and vacuum is 10 kPa and −80 kPa, respectively. The last series of the tests considers the specimens cured in vacuum at −80 kPa gauge pressure. The concentrations of the plastic waste at 10% and 40% are focused. The initial density and water content of the specimens are 1240 kg/m³ and 14%, respectively. The curing temperature is also the same as the highest one adopted in the first test series. In all test series, the duration of curing is 4 hours. Thereafter, based on ASTM Standard D2166M-16, an unconfined compressive test is conducted to measure the strength of waste mixture cured in different conditions. The specimen is loaded at a shearing rate of 1 mm min⁻¹. The axial stress and deformation of the specimen is determined using a load cell and a liner variable different transformer, respectively. The peak stress measured represents the unconfined compressive strength of the specimen.

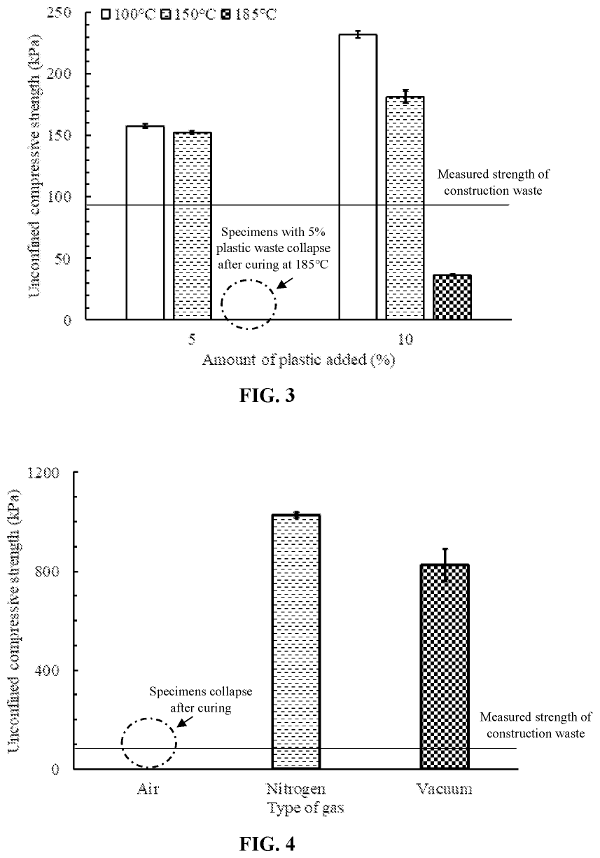

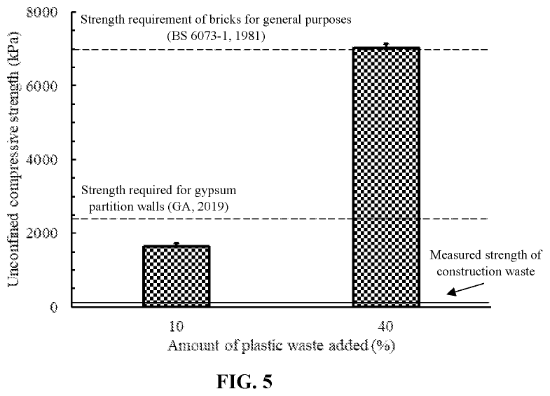

FIG. 3 shows the strength of the construction waste with plastic waste, PP, after curing in air. When the curing temperature (i.e., 100° C. and 150° C.) is lower than the melting point of plastic waste, the strength of waste mixture increases with an increase in the amount of plastic waste added because more particles of plastic waste may gain sufficient energy to melt and bind the construction waste. Compared with the strength of construction waste without treatment, the strength of construction waste with 5% and 10% plastic waste is increased by at least 65% and 95%, respectively. However, the strength of the waste reduces with an increase in the curing temperature. At the highest curing temperature, the specimens prepared with 5% plastic waste collapse after curing while the strength of construction waste with 10% plastic is even lower than that of the construction waste without treatment. These results demonstrate that the curing in air at a temperature higher than the melting point of plastic waste does not always guarantee that the plastic waste can be melted to reinforce the construction waste. The presence of construction waste and the impurities in the waste can affect the melting point of plastic waste. It is difficult and impractical to precisely control the curing temperature for melting. Besides, in air curing, the plastic waste can undergo oxidation (e.g., combustion) and generate toxic gases. Therefore, curing the waste mixture in the environment with inert gases or in vacuum overcomes the limitations of curing the waste mixture in air. FIG. 4 presents the compressive strength of the construction waste added with 5% plastic waste after curing in different types of gas. The curing temperature is the same as the highest one shown in FIG. 3. When the specimens are cured in air, they collapse after curing. Only the specimens cured in nitrogen and vacuum develop material strength which is at least 8 times greater than the construction waste without plastic waste. This further supports that the new method can avoid the oxidation of plastic waste and facilitate the reinforcement of construction waste using plastic waste. To comprehensively examine the performance of the waste mixture produced using the new method, different contents of plastic waste are considered while the highest temperature given in FIG. 3 is adopted for curing. FIG. 5 shows the measured unconfined compressive strength of construction waste mixed with different amounts of PP waste after curing in vacuum. The strength of the waste mixture increases with an increase in the amount of plastic waste added. With reference to the construction waste without treatment, the strength of construction waste with 10% and 40% plastic waste is increased by around 17 times and 75 times, respectively. All the above results demonstrate that the newly developed method overcomes the limitations of existing technologies in reusing plastic waste for binding construction waste. Such new method is also more comprehensive and applicable to a variety of plastic wastes. More importantly, the strength of construction waste with 40% plastic waste exceeds the strength required for typical gypsum partition walls (i.e., 2.4 MPa) (GA, 2019) and the strength requirement of bricks adopted for general purposes (i.e., 7 MPa) (BS 6073-1, 1981). This supports that the sustainable cementless materials produced by the new method developed are suitable for many applications including construction of partition walls and pavements. The new method developed can also reduce reliance on typical carbon-intensive construction materials, such as cement and concrete, in order to promote sustainability and achieve carbon neutrality.

It is understood that many additional changes in the details, materials, and steps herein described and illustrated to explain the nature of the subject matter may be applied by those skilled in the art within the principle and scope of this invention as expressed in the appended key features.

### REFERENCES

Akinyele, J. O., Igba, U. T., Adigun, B. G., 2020. Effect of waste PET on the structural properties of burnt bricks. Scientific African, 7, e00301.
BS 6073-1, 1981. British Standard-Precast concrete masonry units (Part 1: Specification for precast concrete masonry units). British Standards Institution, United Kingdom.
Dalhat, M. A., Wahhab, H. A. A., 2016. Cement-less and asphalt-less concrete bounded by recycled plastic. Construction and Building Materials, 119, 206-214.
Eurostat, 2022. Generation of waste by waste category, hazardousness and NACE Rev. 2 activity. (assessed on 16 Jun. 2023)
GA, 2019. GA-235-Gypsum board typical mechanical and physical properties. Gypsum Association, United State. https://www.americangypsum.com/sites/default/files/2022-01/ga-235_gypsum_board_typical_mechanical_and_physical_properties.pdf (Assessed on 22 Jun. 2023)
Ibrahim, H. A., Goh, Y., Ng, Z. A., Yap, S. P., Mo, K. H., Yuen, C. W., Abutaha, F., 2020. Hydraulic and strength characteristics of pervious concrete containing a high volume of construction and demolition waste as aggregates. Construction and Building Materials, 253, 119251.
IPCC (Intergovernmental Panel on Climate Change), 2019. Global Warming of 1.5° C. https://www.ipcc.ch/site/assets/uploads/sites/2/2022/06/SR15_Full_Report_HR.pdf [assessed on 16 Jun. 2023]
Monteiro, P. J., Miller, S. A., Horvath, A., 2017. Towards sustainable concrete. Nature Materials, 16 (7), 698-699.
Nizamuddin, S., Jamal, M., Gravina, R., Giustozzi, F., 2020. Recycled plastic as bitumen modifier: The role of recycled linear low-density polyethylene in the modification of physical, chemical and rheological properties of bitumen. Journal of Cleaner Production, 266, 121988.
QIRI (Qianzhan Industrial Research Institute), 2018. Report of market research and investment forecast analysis on China construction and demolition waste disposal industry, 2022-2027. https://bg.qianzhan.com/report/detail/459/181228-0c3486f5.html (assessed on 16 Jun. 2023)
Shi, C., Li, Y., Zhang, J., Li, W., Chong, L., Xie, Z., 2016. Performance enhancement of recycled concrete aggregate-a review. Journal of Cleaner Production, 112, 466-472.
Statista, 2023. Global plastic production 1950-2021. https://www.statista.com/statistics/282732/global-production-of-plastics-since-1950/(assessed on 16 Jun. 2023)
Sun, P., Huang, X., Xu, C., 2022. Flashpoint and burning of thin molten plastic pool above hot boundary. Applied Thermal Engineering, 215, 118931.
UKGBC (UK Green Building Council), 2015. Tackling embodied carbon in buildings. https://www.c40knowledgehub.org/s/article/Tackling-embodied-carbon-in-buildings?language=en_US (assessed on 16 Jun. 2023)
USEPA (United States Environmental Protection Agency), 2020. Advancing sustainable materials management: 2018 Facts and figures report. https://www.epa.gov/facts-and-figures-about-materials-waste-and-recycling/advancing-sustainable-materials-management (assessed on 16 Jun. 2023)
Vollmer, I., Jenks, M. J., Roelands, M. C., White, R. J., van Harmelen, T., de Wild, P., van der Lann, G. P., Meirer, F., Keurentjes, J. T. F., Weckhuysen, B. M., 2020. Beyond mechanical recycling: Giving new life to plastic waste. Angewandte Chemie, 59 (36), 15402-15423.
Zulkernain, N. H., Gani, P., Chuan, N. C., Uvarajan, T., 2021. Utilisation of plastic waste as aggregate in construction materials: A review. Construction and Building Materials, 296, 123669.

What is claimed is:

1. A method for preparing a composite construction material, the method comprising:
combining plastic waste and construction waste thereby forming a waste mixture; and
curing the waste mixture under oxygen-free conditions thereby melting or softening at least a portion of the plastic waste and forming the composite construction material.

2. The method of claim 1, wherein the construction waste comprises concrete, bitumen, asphalt, rubble, rock, aggregate, construction debris, crushed rock, stone, concrete rubble, soil, crushed glass, brick, tile, ceramic, gypsum board, or a mixture thereof.

3. The method of claim 1, wherein the plastic waste comprises polyethylene, polypropylene, polyethylene terephthalate, polyvinyl chloride, polystyrene, acrylonitrile butadiene styrene, polycarbonate, nylon, poly(methyl methacrylate), polylactic acid (polylactide), polyether sulfone, polyoxymethylene, polyether ether ketone, polyetherimide, polyphenylene oxide, polyphenylene sulphide, polyvinylidene fluoride, polytetrafluoroethylene, or a mixture thereof.

4. The method of claim 1, wherein the plastic waste comprises polyethylene, polypropylene, or a mixture thereof.

5. The method of claim 1, wherein the composite construction material comprises at least 5% by weight of the plastic waste relative to the total weight of plastic waste and construction waste.

6. The method of claim 1, wherein the composite construction material comprises at least 10% by weight of the plastic waste relative to the total weight of plastic waste and construction waste.

7. The method of claim 1, wherein the step of combining plastic waste and construction waste further comprises combining water thereby forming the waste mixture with a gravimetric water content of 5-20%; and moulding the waste mixture prior to curing the waste mixture.

8. The method of claim 1, wherein curing the waste mixture is conducted at a temperature at ±20° C. of a melting point of the plastic waste.

9. The method of claim 1, wherein curing the waste mixture is conducted at a temperature at ±5° C. of a melting point of the plastic waste.

10. The method of claim 1 further comprising the step of determining the melting point of the plastic waste.

11. The method of claim 1, wherein the oxygen-free conditions comprise vacuum or an inert atmosphere comprising nitrogen, carbon dioxide, helium, argon, or a mixture thereof.

12. The method of claim 1, wherein the composite construction material has an unconfined compressive strength of at least 2.4 MPa measured in accordance with ASTM D2166M-16.

13. The method of claim 1, wherein the construction waste comprises construction debris, crushed rock, stone, concrete rubbles, soil, or a mixture thereof; the plastic waste comprises polyethylene, polypropylene, polyethylene terephthalate, polyvinyl chloride, polystyrene, or a mixture thereof; the composite construction material comprises at least 5-40% by weight of the plastic waste relative to the total weight of plastic waste and construction waste; curing the waste mixture is conducted at a temperature at ±20° C. of a melting point of the plastic waste; and wherein the oxygen-free conditions comprise vacuum or an inert atmosphere comprising nitrogen, carbon dioxide, helium, argon, or a mixture thereof.

14. The method of claim 13, wherein the composite construction material has an unconfined compressive strength of at least 2.4 MPa measured in accordance with ASTM D2166M-16.

15. The method of claim 1, wherein the construction waste comprises construction debris, crushed rock, stone, concrete rubbles, soil, or a mixture thereof; the plastic waste comprises polyethylene, polypropylene, or a mixture thereof; the composite construction material comprises at least 10-40% by weight of the plastic waste relative to the total weight of plastic waste and construction waste curing the waste mixture is conducted at a temperature at ±5° C. of a melting point of the plastic waste; and wherein the oxygen-free conditions comprise vacuum or an inert atmosphere comprising nitrogen, carbon dioxide, helium, argon, or a mixture thereof.

16. The method of claim 14, wherein the composite construction material has an unconfined compressive strength of 2.4-7 MPa measured in accordance with ASTM D2166M-16.

17. The method of claim 15 further comprising the step of determining the melting point of the plastic waste.

18. The method of claim 1 further comprising applying a surface treatment to at least one surface of the composite construction material, wherein the surface treatment comprises a radiative cooling coating, a radiative cooling paint, or a mixture thereof.

19. The method of claim 18, wherein the radiative cooling coating comprises silicone and a metal oxide selected from the group consisting of magnesium oxide, aluminium oxide, titanium oxide and silicon oxide.

20. The method of claim 18, wherein the radiative cooling paint comprises titanium dioxide, barium sulphate, and a polyvinylidene fluoride-hexafluoropropylene copolymer.
